(19) United States
(12) Patent Application Publication
(10) Pub. No.: US 2024/0254808 A1
(43) Pub. Date: Aug. 1, 2024

(54) ADAPTER FOR AN ELECTRONIC DOOR LOCK

(71) Applicant: IGLOOCOMPANY PTE. LTD., Singapore (SG)

(72) Inventors: Liqiang KHOO, Singapore (SG); Chee Kin Julius PANG, Singapore (SG); Yung Ling MAH, Singapore (SG); Matthew Mantik NG, Singapore (SG); Zhi Peng LUO, Singapore (SG)

(73) Assignee: IGLOOCOMPANY PTE. LTD., Singapore (SG)

(21) Appl. No.: 18/564,087

(22) PCT Filed: May 23, 2022
(86) PCT No.: PCT/SG2022/050341

§ 371 Date: Nov. 26, 2023

(30) Foreign Application Priority Data
May 27, 2021 (SG) 10202105640S

(51) Int. Cl. E05B 63/00; E05B 9/08; E05B 47/00

(52) U.S. Cl. CPC E05B 63/0004; E05B 47/0012; E05B 9/08; E05B 2047/0017; E05B 2047/002; E05B 2047/0091

(57) ABSTRACT

According to a first aspect of the present disclosure, there is provided an adapter for use in an electronic lock designed to be operatively coupled with a locking element of a door lock cylinder comprising a cylindrical housing having an open end and a receiver gear circumferentially surrounding an exterior of the cylindrical housing configured for operative engagement with a gear mechanism of the electronic lock, a frame coupled to the interior of the cylindrical housing, the frame including a plurality of openings, a plurality of retractable pins bundled in parallel with one another, the plurality of retractable pins adapted for coupling with the plurality of openings whereby some of the plurality of retractable pins conform to the locking element when the adapter is operatively coupled to the locking element.

### TECHNICAL FIELD

The present disclosure generally relates to door locking systems. More particularly, the present disclosure relates to an adapter for an electronic lock designed to be operatively coupled to any door locking assembly.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Electronic locks are commonly used for homes and commercial establishments and replaces the mechanical door lock assembly to provide convenience, increased security and flexibility through the use of password and/or biometric authentication processes replacing the use of a physical key. Installation of an electronic locks on a door lock assembly typically requires professional expertise from a professional locks due to the various types of door lock assemblies used around the world. Where installation is done by a homeowner, instruction manuals are provided to accommodate for the various types of door lock assemblies in order to install the electronic lock. For example, two primary door locking cylinders typically used in door lock assemblies include the American type cylinder and the European locking cylinder or commonly referred to as the Euro Profile cylinder.

The European profile cylinder is designed to operate a European type mortise lock system. Unlike traditional mortise and rim lock cylinders, the European profile cylinder lock uses a single piece of metal to connect both sides of the lock. It uses a single cam component placed between the two sides of the lock and is directly connected with both plugs. It has a housing with a unique shape and is mounted into a door. One side of the European profile cylinder lock is configured to receive a key and the other side may be configured to receive a key or a thumb turn. For homeowners to install an electronic lock on a European profile cylinder lock, the homeowner may have to buy a special adapter to fit a thumb turn, to remove the door cylinder entirely and to install the electronic lock that comes with a door cylinder, or to perform a special fitting to accommodate the electronic lock on to the door. The same problem occurs for the Americal type cylinder lock.

To circumvent the above problem of accommodating the two types of cylinder locks, electronic lock manufacturers will have to provide various adapters or accessories to aid the user or installer in the installation process. Another problem with installing electronic locks is that in order to accommodate either a key-actuated or a thumb turn actuated door lock assemblies, the manufacturer of the electronic lock typically has to provide separate adapters or accessories to accommodate for door lock cylinders that are either key or thumb turn operated. Where adapters or accessories are not provided by the manufacturer, the homeowner would have to purchase these accessories or adapters from hardware appliance stores, leading to additional inconvenience and frustration when these accessories or adapters do not work. In either of these cases, the homeowner or manufacturer would have to provide different adapters to cater to either of these configurations.

This leads to frustration to homeowners and inefficiency which leads to increased manufacturing and distribution costs for the manufacturers.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to a first aspect of the present disclosure, there is provided an adapter for use in an electronic lock designed to be operatively coupled with a locking element of a door lock cylinder comprising a cylindrical housing having an open end and a receiver gear circumferentially surrounding an exterior of the cylindrical housing configured for operative engagement with a gear mechanism of the electronic lock, a frame coupled to the interior of the cylindrical housing, the frame including a plurality of openings, a plurality of retractable pins bundled in parallel with one another, the plurality of retractable pins adapted for coupling with the plurality of openings whereby some of the plurality of retractable pins conform to the locking element when the adapter is operatively coupled to the locking element.

According to various embodiments, the locking element is fixed in position relative to the plurality of retractable pins.

According to various embodiments, the plurality of retractable pins each include a bottom portion and a telescoping portion that is retractable from an extended position to a position at a top of the bottom portion of each of the retractable pin.

According to various embodiments, the plurality of retractable pins each further include an overlapping portion between the telescoping portion and the bottom portion.

According to various embodiments, the telescoping portion includes a first tube and a second tube overlapping with the first tube.

According to various embodiments, the plurality of retractable pins each has a circular cross-section.

According to various embodiments, each retractable pin includes a bottom portion configured for receiving a biasing means that is in engagement with the telescoping portion.

According to various embodiments, the housing includes a base cover configured for operative engagement with a motor frame holder of the electronic lock.

According to various embodiments, the base cover has an opening for receiving a connector that connects a locking element of the electronic lock to the adapter.

According to various embodiments, the locking element is a thumb turn or a key.

According to various embodiments, the door lock cylinder is an American type cylinder.

According to various embodiments, the door lock cylinder is a European profile cylinder.

According to a second aspect of the present disclosure, there is provided an electronic lock including an adapter designed to be operatively coupled with a locking element of a door lock cylinder, the adapter comprising a cylindrical housing having an open end and a receiver gear circumferentially surrounding an exterior of the cylindrical housing configured for operative engagement with a gear mechanism of the electronic lock, a frame coupled to the interior of the cylindrical housing, the frame including a plurality of openings, a plurality of retractable pins bundled in parallel with one another, the plurality of retractable pins adapted for coupling with the plurality of openings whereby some of the plurality of retractable pins conform to the locking element when the adapter is operatively coupled to the locking element.

According to various embodiments, the locking element is fixed in position relative to the plurality of retractable pins.

According to various embodiments, the plurality of retractable pins each include a bottom portion and a telescoping portion that is retractable from an extended position to a position at a top of the bottom portion of each of the retractable pin.

According to various embodiments, the plurality of retractable pins each further include an overlapping portion between the telescoping portion and the bottom portion.

According to various embodiments, the plurality of retractable pins each has a circular cross-section.

According to various embodiments, the plurality of retractable pins each pin includes a bottom portion configured for receiving a biasing means that is in engagement with the telescoping portion.

According to various embodiments, the housing includes a base cover configured for operative engagement with a motor frame holder of the electronic lock.

According to various embodiments, the base cover has an opening for receiving a connector that connects a locking element of the electronic lock to the adapter.

According to various embodiments, the locking element is a thumb turn or a key.

According to various embodiments, the door lock cylinder is an American type cylinder.

According to various embodiments, the door lock cylinder is a European profile cylinder.

According to various embodiments, the telescoping portion includes a first tube and a second tube overlapping with the first tube.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 illustrates a perspective view of an adapter for an electronic lock for installing on a door lock according to various embodiments;

FIG. 2a illustrates a top view of an exemplary embodiment of the adapter according to various embodiments;

FIG. 2b illustrates a side view of an exemplary embodiment of the adapter according to various embodiments;

FIG. 3 illustrates a side view of a retractable pin for use in the adapter according to various embodiments;

FIG. 4 illustrates an exploded perspective view of the internal components of the electronic lock and the adapter interacting with other components according to various embodiments;

FIG. 5 illustrates an exploded perspective view of the internal components of the electronic lock and the adapter interacting with other components according to another embodiment;

FIG. 6 illustrates a perspective view of an adapter installed on a door according to various embodiments;

FIG. 7a illustrates a side view of a first step of a method of installing the electronic lock on the door according to various embodiments.

FIG. 7b illustrates a side view of a second step of a method of installing the electronic lock on the door according to various embodiments.

FIG. 8 illustrates a perspective view of an adapter installed on a door according to another embodiment;

FIG. 9 illustrates a perspective view of an adapter installed on a door according to another embodiment;

FIG. 10a illustrates a side view of a first step of a method of installing the electronic lock on the door according to various embodiments.

FIG. 10b illustrates a side view of a second step of a method of installing the electronic lock on the door according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

To achieve the stated features, advantages and objects, the present disclosure provides a universal adapter for an electronic lock that is configured to be operatively coupled to a variety of door assemblies such as a key-actuated or a thumb turn door lock. The electronic lock together with the adapter is also configured for installation on any cylinder lock type to improve efficiency in the installation of the electronic lock on the door.

To accomplish the foregoing objects, the present invention provides a universal adapter comprising a frame having a plurality of openings therethrough, a plurality of pins closely packed in parallel, each pin having a top and bottom ends and a rounded cross section shape. The bottom ends pass through the openings in the frame and are slidably mounted thereto. Biasing members are disposed on each pin urging the top end away from the frame, and a housing partially enclosing the frame. The top ends of the pins in their extended state are exposed through the housing. The plurality of pins bundled in parallel within the frame and are retractable. The pins can displace longitudinally and are biased by spring force away from the frame onto which the pins are slidably held. When the adapter is forced over a thumb turn or a key inserted into a lock, a group of pins among the plurality of pins are pushed inward toward the frame and into the housing thereby conforming the pins to the contours of thumb turn or key. Applying a torque to the adapter transfers the torque to the bundled pins to the thumb turn or the key.

The present invention therefore provides an adapter having bundled pins that have a circular cross-section without any sharp corners. The rounded pins avoid many problems caused by sharp edged or flat sided pins which can cause scratches or marks on the thumb-turn or key.

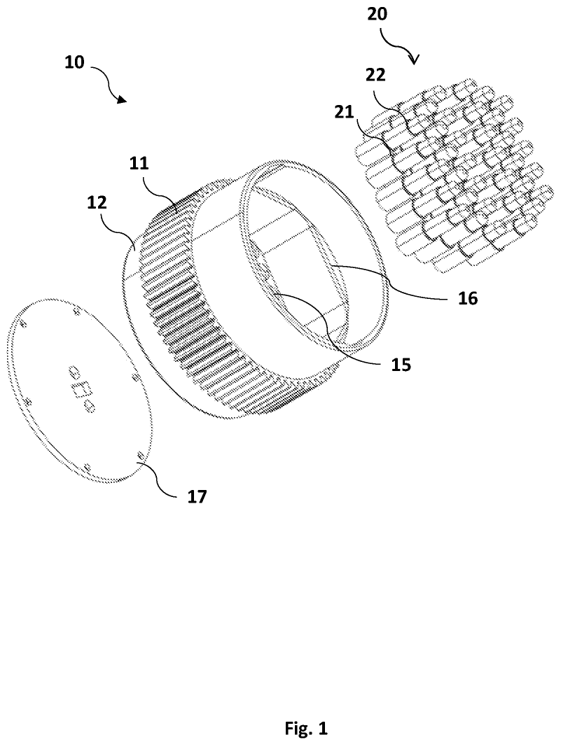

FIG. 1 illustrates a perspective view of an adapter 10 for use in an electronic lock for installing on a door lock according to various embodiments. The adapter 10 comprises a housing 12 having an open end exposing a plurality of pins 20 packed or bundled in parallel. A frame 16 is lodged within the housing 12 for receiving a plurality of retractable pins 20. The frame 16 includes a plurality of openings 15, each opening 15 for receiving a retractable pin 20. The housing 12 has a receiver gear 11 circumferentially surrounding the exterior of the housing that is configured to interact with a gear mechanism of the electronic lock, details of which will be explained hereinafter.

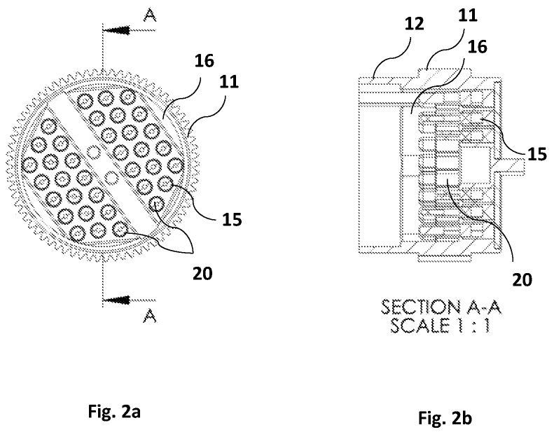

The housing 12 has a base cover 17 that is configured to be received by a motor frame holder of an electronic lock. The base cover 17 fits within the motor frame holder so that it provides a secure fit via an interference fit or frictional fit between the adapter 10 and the motor frame holder. The base cover 17 includes an opening for receiving a connector that connects the locking element of the electronic lock to the adapter 10. The locking element, for example, the key or thumb turn, allows a user to manually open the door mechanically without use of the motor within the electronic lock. The base cover 17 will be connected to the housing 12. The screws will be connecting the 2 screw holes on the base cover 17 in FIG. 2a. The purpose of the base cover 17 is to secure the allocation of the pins 20. A spacer between the base cover and the frame of the housing is provided to accommodate a wider range of keys, for example, keys that may have a greater depth.

FIG. 2a and FIG. 2b provide a top view and a side view respectively of the interaction between the retractable pins 20 and the housing 12. Each of the retractable pins 20 has a top end and a bottom end, and each retractable pin 20 is driven by a spring or any other similar mechanism that allows pins to be extended and retracted. The retractable pin 20 includes a bottom end 21 and a telescoping portion 22 that retracts from an extended position to a position at the top of the bottom end 21 of the retractable pin 20. The bottom end 21 of each retractable pin 20 is attached to one of the plurality of openings 15 on the frame. In one embodiment, the telescoping portion 22 includes at least a first tube. In another embodiment, the telescoping portion 22 includes at least a first tube and a second tube. Collectively, the retractable pins 20 are bundled in parallel with one another and collectively, they conform to the shape of a locking element, for example, a key or a thumb turn, of a door assembly when the adapter is pressed against the locking element when the electronic door lock is installed on the door assembly.

Referring back to FIG. 2a, in some embodiments, the frame 16 is polygonal shaped, but is not limited thereto. In some embodiments, the frame 16 can be any shape within the cylindrical housing 12 as long as the dimensions are suitable to receive the locking element, i.e. the key or the thumb turn, of the door lock assembly to which the electronic lock is attached to. Details of the adapter in operation will be explained hereinafter.

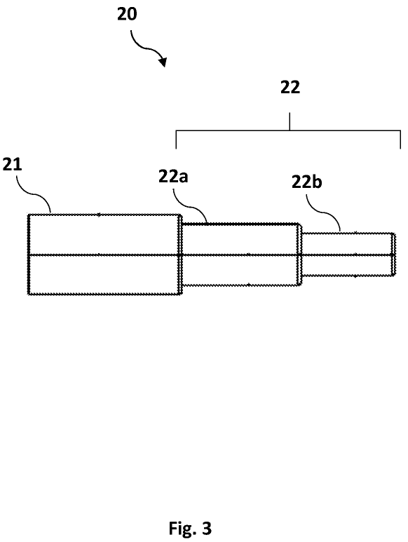

FIG. 3 illustrates a side view of a retractable pin 20 configured to fit each of the openings 15 in the frame. Each retractable pin 20 has an overlapping portion between the telescoping portion 22 and the bottom end 21 of the pin 20. In some embodiments, the telescoping portion 22 includes at least one tube. In some embodiments, the telescoping portion 22 includes a first tube 22a and a second tube 22b. Advantageously, this provides for added stability when the telescoping portion 22 is fully extended. The overlapping portion between the telescoping portion and the bottom end can vary in distance. However, having a longer extension range is advantageous as long as the stability of the retractable pin 20 is not compromised. The bottom end of each retractable pin 20 is configured to receive a coiled spring (not shown) that engages the telescoping portion 22. The coiled spring maintains the extended position of the pin 16 so that the top end of the telescoping portion is biased or urged away from the bottom end 21. Each coiled spring is installed longitudinally within each bottom end of the pin and biases the top end of the pin away from the bottom end. The coiled spring 14 is preferably preloaded when the retractable pin 20 is in its fully extended state. The bottom end 21 has a peripheral diameter that is bigger than the telescoping portion 22 in order to accommodate the telescoping portion. The diameter of the first tube is greater than the diameter of the second tube. In some embodiments, the length of the bottom end is about 9.0 mm and the length of the exposed portion of the telescoping portion is about 14.0 mm. In some embodiments, the length of the first tube is about 7 mm and the length of the second tube is about 5.5 mm. The first tube and the second tube includes an overlapping portion that overlaps with each other. The bottom end 21 has a length that is longer than the first tube and the second tube, and the first tube has a length that is longer than the second tube.

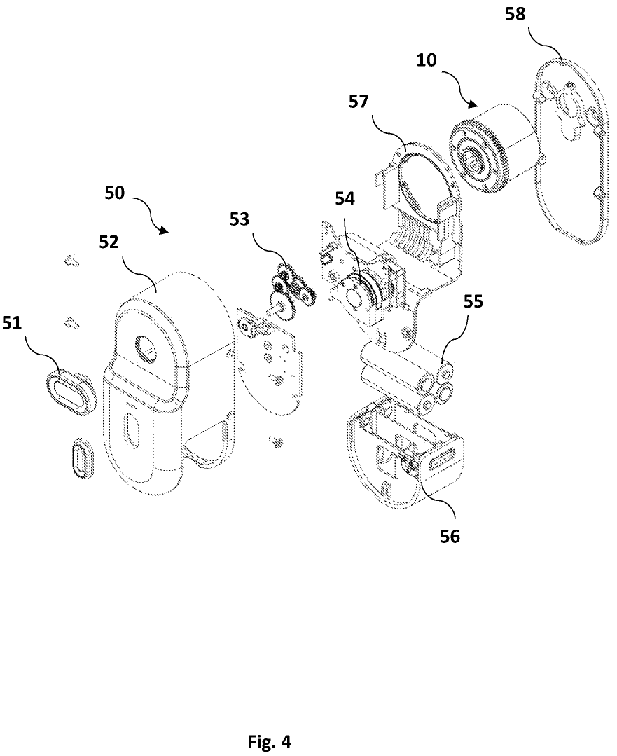

FIG. 4 illustrates a perspective exploded view of an embodiment of an electronic lock 50 configured to receive the adapter 10 within the electronic lock 50. The electronic lock 50 has a housing 52 that includes a gear mechanism 53 operably communicating with a motor 54 controlled by a controller (not shown) for locking and unlocking a door to which the electronic lock is attached to. The gear mechanism 53 is operably communicable with the adapter 10 that directly connects with the locking element of a door lock cylinder of a door assembly. In some embodiments, the gear mechanism 53 is operably communicable with the receiver gear 11 circumferentially surrounding the adapter 53. The electronic lock 50 can be installed on any door that provides access to a building, residential unit, room, hotel room, car, safe, cabinet, or the like. The controller controls a mechanical motor 54 which causes the mechanical motor 54 to open or close the physical lock. The mechanical motor 54 interacts with the associated gear mechanism 53 in order to generate a torque. The associated gear mechanism 53 in turn interacts with the receiver gear 11 of the adapter 10 that will operably rotate the adapter 10 required to move the locking element of the door lock cylinder from a locked position to an unlocked position, and vice versa, when torque from the mechanical motor is generated. The door lock cylinder may take many form factors including padlocks, deadbolts, mortises, rim locks, latches and electro-magnetic door locks. The controller includes a memory 40 that stores digital keys, biometric data, access details, logs of user interactions or associated timestamps and a record of the owner or administrator data. The memory 40 may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magneto resistive Random Access Memory) or a PCRAM (Phase Change Random Access Memory).

The electronic lock 50 includes a power source 55 that provides power supply to the electronic lock. The power source 55 is held by a holder 56 for storing the power source 55. The power source can be a battery energy source, for example, a rechargeable battery.

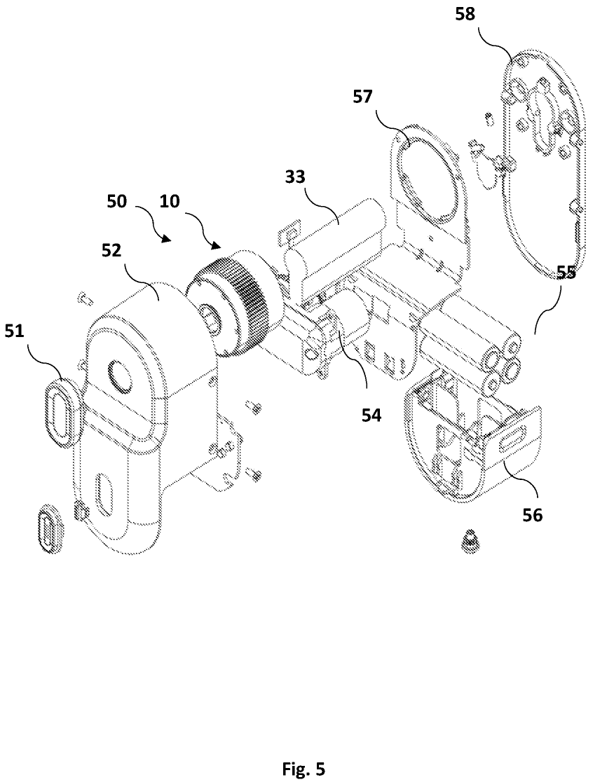

FIG. 5 illustrates a perspective exploded view of another embodiment of an electronic lock 50 configured to receive the adapter 10 within the electronic lock 50. In this embodiment, the adapter 10 is configured to receive a European profile door cylinder 33 of a door blade. Similar to the electronic lock 50 as shown in FIG. 4, the housing 52 of the electronic lock 50 is capable of receiving the door cylinder 33 during the installation process on the door blade. In such cases, the user may wish to replace the existing door cylinder with a new or better door cylinder, and this is done by removing the existing door cylinder, affixing the base plate 58 on the door blade 30 and inserting the new door cylinder 33 through the opening of the base plate 58 and the door cylinder opening on the door blade. As explained in FIG. 4, the electronic lock 50 has a housing 52 that includes a gear mechanism 53 (not shown) operably communicating with a motor 54 controlled by a controller (not shown) for locking and unlocking a door to which the electronic lock is attached to. The gear mechanism 53 is operably communicable with the receiver gear 11 of the adapter 10 that directly connects with the locking element of the door lock cylinder 33. The controller controls a mechanical motor 54 which causes the mechanical motor 54 to open or close the physical lock. The mechanical motor 54 interacts with the associated gear mechanism 53 in order to generate a torque. The associated gear mechanism 53 in turn interacts with the receiver gear 11 of the adapter 10 that will operably rotate the adapter 10 required to move the locking element that conforms to the plurality of retractable pins within the adapter so that the locking element can be moved from a locked position to an unlocked position, and vice versa, when torque from the mechanical motor is generated.

There are various types of European profile door cylinders available on the market today. The common characteristic of the European profile door cylinder is that they all have a profile with equal dimensions, which makes it easy to replace an old cylinder with a new or a better one. A European profile door cylinder typically comprise a body that is capable of receiving a plug which in turn receives a key. Turning the key rotates the plug and moves the cam within the plug which moves the internal lock mechanism which controls the door latch and bolts. At the opposite end of the cylinder that receives a key, there may be another cylinder that receives a key or a thumb turn, depending on the desired use and function of the door.

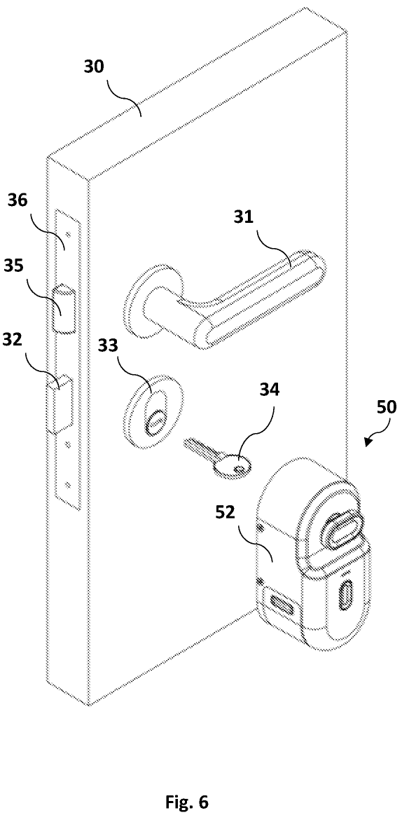

FIG. 6 illustrates an exploded view of the electronic lock 100 configured for for attachment to a door blade 30. The door blade 30 comprises a straight spring latch handle 31 that actuates a spring latch 35 in a door lock 36. A dead bolt 32 is actuated by a lock cylinder 33 that has a key receiver for receiving a key 34. The lock cylinder has on its opposite end towards the door blade a lock actuator pin (not shown) for connection to another locking element, for example, a thumb turn, which by rotation of the lock actuator pin operates the dead bolt between a fully retracted position and a fully extended position, which is typically called a dead position. In some embodiments, the locking element is a key. In some embodiments, the door cylinder 33 is a European profile door cylinder. In some embodiments, the door cylinder 33 is a American profile door cylinder. In operation, the electronic lock is installed over the locking element 34 while being received by the lock cylinder 33. The plurality of retractable pins 20 within the adapter of the electronic lock 100 receives the locking element 34 by having some of the plurality of pins conforming to the shape of the locking element 34 thereby causing the locking element to be fixed in position relative to the plurality of retractable pins.

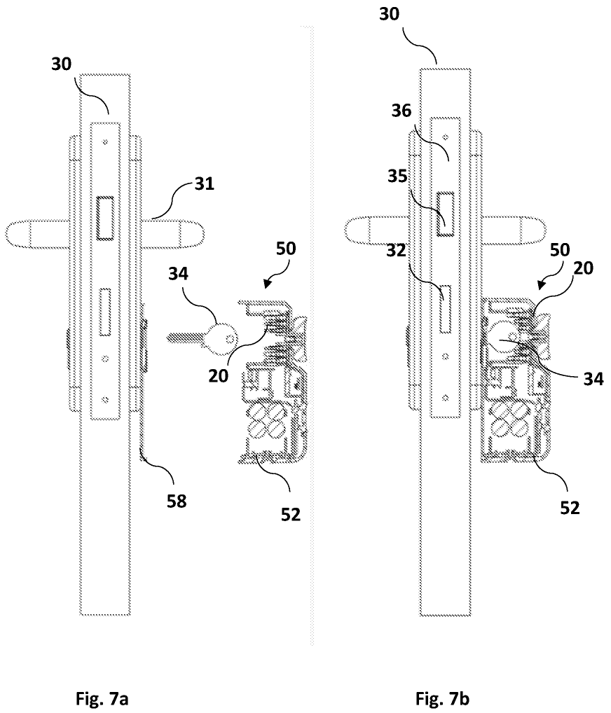

FIGS. 7a and 7b illustrate side views of the electronic lock 50 and the adapter 20 for attachment to a door blade 30. FIG. 7a shows a first step of installing the electronic lock 50 on the door blade 30. When in use, a user who wishes to install the electronic lock 50 on the door blade 30 can do so by first installing a base plate 58 on the door blade 30. The base plate 58 has an opening that is dimensioned to receive the door cylinder 33 on the door blade 30. The base plate 58 is attached to the door blade 30 via screws that are screwed into the door blade 30 to affix the base plate 58 to the door blade 30. The locking element 34, for example the key, is subsequently inserted into the door cylinder 33 to an unlocked position.

FIG. 7b shows a second step of installing the electronic lock 50 on the door blade 30. Once it is affixed to the door blade, the housing 52 of the electronic lock, which includes the adapter 20 within the electronic lock 50, is subsequently placed over the base plate 58 and the locking element 34 so that the electronic lock 50 can be attached to the base plate 58 via screws. At this time, the plurality of pins within the adapter 20 receives the locking element such that some of the plurality of pins are variably retracted in order to conform to the shape of the locking element. The locking element 34 remains fixed in position relative to the plurality of retractable pins 20. Once the housing 52 of the electronic lock is attached to the base plate, the locking element is fixed in position within the plurality of pins. This means that in use, when the receiver gear 11 of the housing of the adapter is operably rotated by the gear mechanism within the electronic lock for rotating the locking element to an unlocked or locked position, the locking element will rotate accordingly to the unlocked or locked position corresponding to the rotation of the receiver gear.

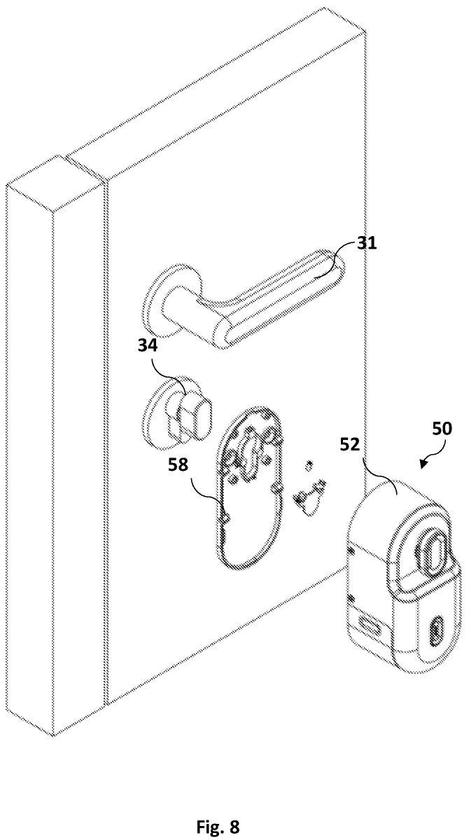

FIG. 8 illustrates an exploded view of the electronic lock 50 configured for attachment to a door blade 30. In this embodiment, the door cylinder 34 includes a locking element 34, for example, a thumb turn, for locking and unlocking the door instead of a key as illustrated in previous figures. A similar method of installation applies as explained in the previous figures. When in use, a user who wishes to install the electronic lock 50 on the door can do so by first installing a base plate on the door blade 30. Before doing so, the thumb turn is removed from the door before attaching the base plate 58 on the door blade 30. As before, the base plate 58 has an opening that is dimensioned to receive the door cylinder 34 on the door blade 30. The base plate 58 is attached to the door blade 30 via screws that are screwed into the door to affix the base plate to the door blade. The locking element 34 is placed back in position on the door cylinder in the unlocked position. Once the thumb turn is affixed to the door blade, the housing 52, which includes the adapter within the electronic lock 50, is subsequently placed over the base plate 58 and the thumb turn 34 so that the electronic lock 50 can be attached to the base plate 58 via screws. At this time, the plurality of pins within the adapter 20 receives the locking element such that some of the plurality of pins are variably retracted in order to conform to the shape of the locking element. The locking element 34 remains fixed in position relative to the plurality of retractable pins 20. Once the housing 52 of the electronic lock is attached to the base plate, the locking element is fixed in position within the plurality of pins. This means that in use, when the receiver gear 11 of the housing of the adapter is operably rotated by the gear mechanism within the electronic lock for rotating the thumb turn to an unlocked or locked position, the thumb turn will rotate accordingly to the unlocked or locked position corresponding to the rotation of the receiver gear.

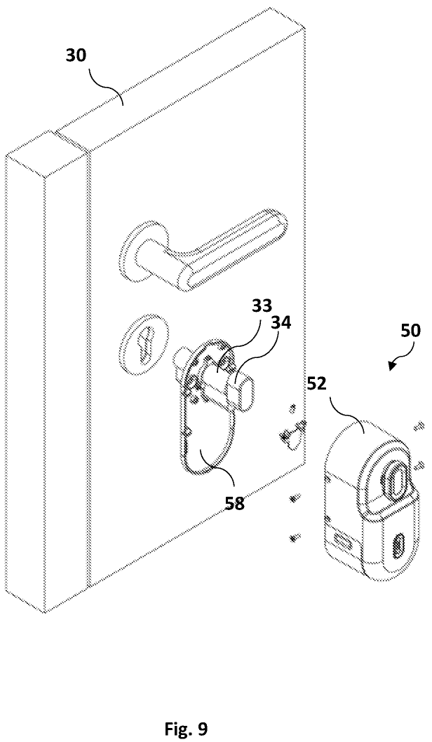

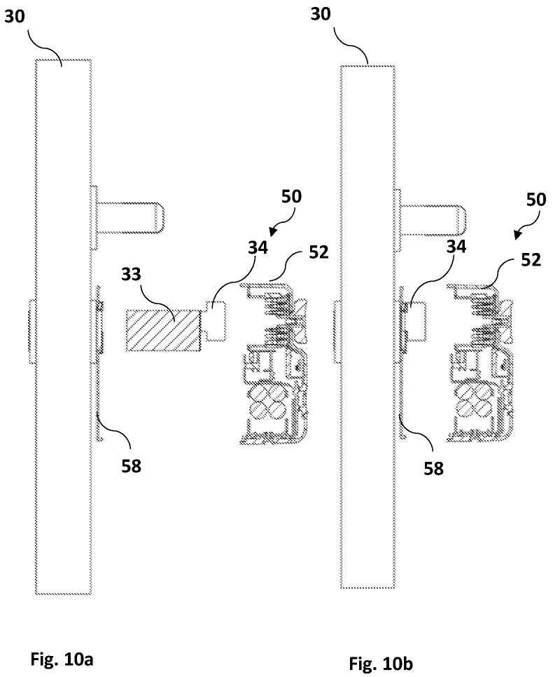

FIG. 9 illustrates an exploded view of yet another embodiment of an electronic lock 50 configured for attachment to a door blade 30. In this embodiment, the entire door cylinder 33 is removed from the door blade 30 and installed together with the base plate of the electronic lock. In this embodiment, a European profile door cylinder is used which typically comprise a body capable of receiving a plug which in turn receives a key at one end and a key or a thumb turn at the opposite end. Turning the key rotates the plug and moves the cam within the plug which moves the internal lock mechanism which controls the door latch and bolts. At the opposite end of the cylinder that receives a key, there may be another cylinder that receives a key or a thumb turn, depending on the desired use and function of the door. The body includes a cam that receives a key for rotating the plug and moving the cam within the plug which moves the internal lock mechanism to lock or unlock the latch. FIG. 10a shows a first step of installing the electronic lock on the door. When in use, a user who wishes to install the electronic lock 100 on the door can do so by first removing the door cylinder 33 from the door blade 30. The base plate has an opening that is dimensioned to receive the door cylinder frame on the door blade. The base plate is attached to the door blade via screws that are screwed into the door to affix the base plate to the door blade. In one embodiment, the next step is to reinsert the door cylinder through the base plate and the door blade in its original position. In order to accommodate the insertion of the door cylinder through the base plate, the thumb turn may have to be removed from the door cylinder first and replaced once the door cylinder is in its original position. FIG. 10b shows the next step of installing the electronic lock on the door. The housing of the electronic lock, which includes the adapter within the electronic lock, is subsequently placed over the base plate and the thumb turn so that the electronic lock can be attached to the base plate via screws. At this time, the plurality of pins within the adapter 20 receives the locking element such that some of the plurality of pins are variably retracted in order to conform to the shape of the locking element. The locking element 34 remains fixed in position relative to the plurality of retractable pins 20. Once the housing 52 of the electronic lock is attached to the base plate, the locking element is fixed in position within the plurality of pins. This means that in use, when the receiver gear 11 of the housing of the adapter is operably rotated by the gear mechanism within the electronic lock for rotating the thumb turn to an unlocked or locked position, the thumb turn will rotate accordingly to the unlocked or locked position corresponding to the rotation of the receiver gear.

FIGS. 10a and 10b illustrate side views of the electronic lock 50 configured for attachment to a door blade 30. FIG. 10a shows a first step of installing the electronic lock 50 on a door blade 30. When in use, a user who wishes to install the electronic lock 50 on the door blade 30 can do so by first installing a base plate 58 on the door blade 30. The base plate 58 has an opening that is dimensioned to receive the door cylinder 33 on the door blade 30. The base plate 58 is attached to the door blade 30 via screws that are screwed into the door blade 30 to affix the base plate 58 to the door blade 30. The locking element 34, for example a thum turn, is subsequently inserted into the door cylinder 33 to an unlocked position.

FIG. 10b shows a second step of installing the electronic lock 50 on the door blade 30. Once it is affixed to the door blade, the housing 52 of the electronic lock 50, which includes the adapter 20 within the electronic lock 50, is subsequently placed over the base plate 58 and the locking element 34 so that the electronic lock 50 can be attached to the base plate 58 via screws. At this time, the plurality of pins within the adapter 20 receives the locking element 34 such that some of the plurality of pins are variably retracted in order to conform to the shape of the locking element. The locking element 34 remains fixed in position relative to the plurality of retractable pins 20. Once the housing 52 of the electronic lock is attached to the base plate, the locking element is fixed in position within the plurality of pins. This means that in use, when the receiver gear 11 of the housing of the adapter is operably rotated by the gear mechanism within the electronic lock for rotating the locking element to an unlocked or locked position, the locking element will rotate accordingly to the unlocked or locked position corresponding to the rotation of the receiver gear.

In some embodiments, the electronic lock further includes a wireless transceiver (not shown) for wireless communication with a remote access management system or an application server through a network. In some embodiments, the wireless transceiver can communicate wirelessly with a user device or through the remote access management system via the network. Such electronic locks may be referred to as ‘smart locks’ and may rely on a single factor or multi-factor authentication methods for unlocking the electronic locking device. Where increased security is desired, multi-factor authentication is used. A multi-factor authentication is based on two or more factors, and these factors are based on what the user knows and who the user is. For example, factors that are based on what the user knows may include a pre-configured password issued by the owner or administrator, or a server-generated password or a one-time password. Factors that are based on who the user is include biometric information including facial recognition or fingerprint information. Other embodiments include electronic locks with no access to a remote access management system and those with access to a remote access management system.

In various embodiments, the wireless transceiver can communicate via any of various technologies, such as a cellular network, a short-range wireless network, a wireless local area network (WLAN), etc. The cellular network can be any of various types, such as code division multiple access (CDMA), time division multiple access (TDMA), global system for mobile communication (GSM), long term evolution (LTE), 3G, 4G, 5G, etc. The short-range wireless network can also be any of various types, such as Bluetooth, Bluetooth Low Energy (BLE), near field communication (NFC), NB-IoT, etc.

As used herein, the term ‘controller’ broadly refers to and is not limited to single or multi-core general purpose processor, a special purpose processor, a conventional processor, a graphical processing unit, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit, a system on a chip (SOC), and/or a state machine.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An adapter for use in an electronic lock designed to be operatively coupled with a locking element of a door lock cylinder comprising:
a cylindrical housing having an open end and a receiver gear circumferentially surrounding an exterior of the cylindrical housing configured for operative engagement with a gear mechanism of the electronic lock;
a frame coupled to the interior of the cylindrical housing, the frame including a plurality of openings;
a plurality of retractable pins bundled in parallel with one another, the plurality of retractable pins adapted for coupling with the plurality of openings whereby some of the plurality of retractable pins conform to the locking element when the adapter is operatively coupled to the locking element.

2. The adapter according to claim 1, wherein the locking element is fixed in position relative to the plurality of retractable pins.

3. The adapter according to claim 1, wherein the plurality of retractable pins each include a bottom portion and a telescoping portion that is retractable from an extended position to a position at a top of the bottom portion of each of the retractable pin.

4. The adapter according to claim 3, wherein the plurality of retractable pins each further include an overlapping portion between the telescoping portion and the bottom portion.

5. The adapter according to claim 3, wherein the telescoping portion includes a first tube and a second tube overlapping with the first tube.

6. The adapter according to claim 1, wherein the plurality of retractable pins each has a circular cross-section.

7. The adapter according to claim 1, wherein the plurality of retractable pins each pin includes a bottom portion configured for receiving a biasing means that is in engagement with the telescoping portion.

8. The adapter according to claim 1, wherein the housing includes a base cover configured for operative engagement with a motor frame holder of the electronic lock.

9. The adapter according to claim 1, wherein the base cover has an opening for receiving a connector that connects a locking element of the electronic lock to the adapter.

10. The adapter according to claim 1, wherein the locking element is a thumb turn or a key.

11. The adapter according to claim 1, wherein the door lock cylinder is an American type cylinder.

12. The adapter according to claim 1, wherein the door lock cylinder is a European profile cylinder.

13. An electronic lock including an adapter designed to be operatively coupled with a locking element of a door lock cylinder, the adapter comprising:
a cylindrical housing having an open end and a receiver gear circumferentially surrounding an exterior of the cylindrical housing configured for operative engagement with a gear mechanism of the electronic lock;
a frame coupled to the interior of the cylindrical housing, the frame including a plurality of openings;
a plurality of retractable pins bundled in parallel with one another, the plurality of retractable pins adapted for coupling with the plurality of openings whereby some of the plurality of retractable pins conform to the locking element when the adapter is operatively coupled to the locking element.

14. The electronic lock according to claim 13, wherein the locking element is fixed in position relative to the plurality of retractable pins.

15. The electronic lock according to claim 13, wherein the plurality of retractable pins each include a bottom portion and a telescoping portion that is retractable from an extended position to a position at a top of the bottom portion of each of the retractable pin.

16. The electronic lock according to claim 15, wherein the plurality of retractable pins each further include an overlapping portion between the telescoping portion and the bottom portion.

17. The electronic lock according to claim 13, wherein the plurality of retractable pins each has a circular cross-section.

18. The electronic lock according to claim 13, wherein the plurality of retractable pins each pin includes a bottom portion configured for receiving a biasing means that is in engagement with the telescoping portion.

19. The electronic lock according to claim 13, wherein the housing includes a base cover configured for operative engagement with a motor frame holder of the electronic lock.

20. The electronic lock according to claim 13, wherein the base cover has an opening for receiving a connector that connects a locking element of the electronic lock to the adapter.

21. The electronic lock according to claim 13, wherein the locking element is a thumb turn or a key.

22. The electronic lock according to claim 13, wherein the door lock cylinder is an American type cylinder.

23. The electronic lock according to claim 13, wherein the door lock cylinder is a European profile cylinder.

24. The electronic lock according to claim 15, wherein the telescoping portion includes a first tube and a second tube overlapping with the first tube.
